(19) United States
(12) Patent Application Publication
(10) Pub. No.: US 2006/0228526 A1
(43) Pub. Date: Oct. 12, 2006

(54) Disposable place mat manufactured out of embossed paper which has publicity printed on its upper face and which serves as a cleaning device once it has been used

(75) Inventor: Augusto Errazuriz, Santiago (CL)

Correspondence Address: BANNER & WITCOFF, 1001 G STREET N W, SUITE 1100, WASHINGTON, DC, 20001, US

(73) Assignee: COMERCIAL FERAGUS LTDA., Santiago (CL)

(21) Appl. No.: 11/401,296

(22) Filed: Apr. 11, 2006

(30) Foreign Application Priority Data
Apr. 12, 2005 (CL) 829-2005

(51) Int. Cl. B32B 1/00

(52) U.S. Cl. 428/174; 428/195.1

(57) ABSTRACT

This invention refers to a disposable place mat (1) made of embossed paper bearing publicity on its upper face, in order for said place mat to be used as a form of protection of the table or tray, as a publicity means and at the same time serve as a device for cleaning trays or tables at restaurants. This invention is mainly intended for fast-food restaurants or restaurants with high client turnover, where the serving staff set place mats on the trays or tables, in order for them to serve as a tablecloth acting as a barrier between the tray or table and the plate on which food is served. In general these types of place mats have some sort of publicity printed on the surface of the upper face (2). However, the problem that arises, both for the staff and the user, is that said mat cannot be used as a cleaning device, so that special absorbent cloths have to be used for that purpose. Moreover, the place mat, as it is made of paper, is disposable, is thrown away and loses its ability to act as a cleaning device. To this aim, the use of embossed paper for the manufacturing of said disposable place mat is proposed.

### FIELD OF APPLICATION OF THE INVENTION

The invention subject to this patent application refers to a disposable place mat made of embossed paper bearing publicity on its upper face, in order for said place mat to be used as a publicity means and at the same time serve as a device for cleaning trays or tables at restaurants after it has been used.

### COMMENTS REGARDING PRIOR ART

At present, at fast-food restaurants or restaurants with high client turnover, the staff set on the trays or tables disposable place mats made out of smooth paper, with their upper face bearing publicity. However, those mats fulfill the function of protecting the table or tray and meet the publicity requirements, but do not provide an efficient cleaning function of the surface on which they are placed.

The Swiss document CH 680492 (Echandens) of 15 Sep. 1992, shows a reusable place mat made out of a sheet of paper with the upper face bearing publicity of the restaurant where it is used. This sheet of paper is laminated between two layers of transparent polyester, allowing the mat to be reused. This type of mat provides good protection of the table or tray on which it is placed and makes it possible to exhibit publicity. However, it is not efficient for cleaning purposes, because the polyester does not allow it to absorb liquids and act as a good cleaning device.

The German document DE 10228047 (Boehm) of 19 Feb. 2004, shows a disposable napkin made out of embossed-type paper, which exhibits publicity and is grooved to ensure easy folding. In general, there are many types of napkins that meet the user's cleaning function while also bearing publicity, but they are not made for cleaning the table or tray where the user eats.

### SUMMARY OF THE INVENTION

This invention refers to a disposable place mat made of embossed paper bearing publicity on its upper face, so that the mat can be used as a form of protection of the table or tray, as a publicity means and, at the same time, serve as a device for cleaning trays or tables at restaurants.

This invention is mainly intended for fast-food restaurants or restaurants with high client turnover, where the service staff set mats on the trays or tables in order for them to be used as a tablecloth acting as a barrier between the tray or table and the plate carrying the food. In general this type of place mats has some sort of publicity printed on the upper face. However, the problem that arises, both for the staff and the user, is that said mat cannot be used as a cleaning device, making it necessary to use other implements such as special absorbent cloths to do the cleaning. Likewise, the mat, which is made of non-absorbent paper, is disposable, thrown away and loses the ability to be used as a cleaning device.

This invention is aimed at manufacturing a disposable place mat to act as a tablecloth, with the ability to be used as a publicity means and at the same time to serve as a cleaning device of the trays or tables once the user has finished eating. This invention is also intended for the use of embossed paper to manufacture the above-mentioned place mat.

### BRIEF DESCRIPTION OF DRAWINGS

The drawings set forth below, which are included to provide greater understanding of the invention and are hereby incorporated to and form part of this description, illustrate one embodiment of the invention and, together with the description, serve to explain the principles of the invention.

FIG. No. 1 shows a perspective of the disposable place mat of this invention.

FIG. No. 2 shows a longitudinal cross-section with a first type of embossed paper for the disposable place mat of this invention.

FIG. No. 3 shows a longitudinal cross-section with a second type of embossed paper for the disposable place mat of this invention.

FIG. No. 4 shows a longitudinal cross-section with a third type of embossed paper for the disposable place mat of this invention.

### DESCRIPTION OF THE INVENTION

This invention is intended to be used preferably at fast-food or self-service restaurants, mainly those where consumers use paper place mats to cover the trays where they set the food served at counters to transfer it to a table. This invention is also intended for restaurants with high client turnover, where the staff are required to clean the tables and set down paper place mats for attending to clients.

In order to obtain a place mat that carries out the functions of tablecloth, publicity means and at the same time serves as a cleaning device, this invention proposes the use of embossed paper with a high absorption capacity to achieve those three purposes.

One of the preferred embodiments of this invention for manufacturing a place mat (1), is the use of an embossed paper rectangle. The surface of the upper face (2) of said rectangle has publicity printed on it. The printed publicity may occupy all the face or leave lateral margins that will be provided depending on the user's requirements. The underside (3) is the side that comes into contact with the upper surface of the tray or table, as the case may be.

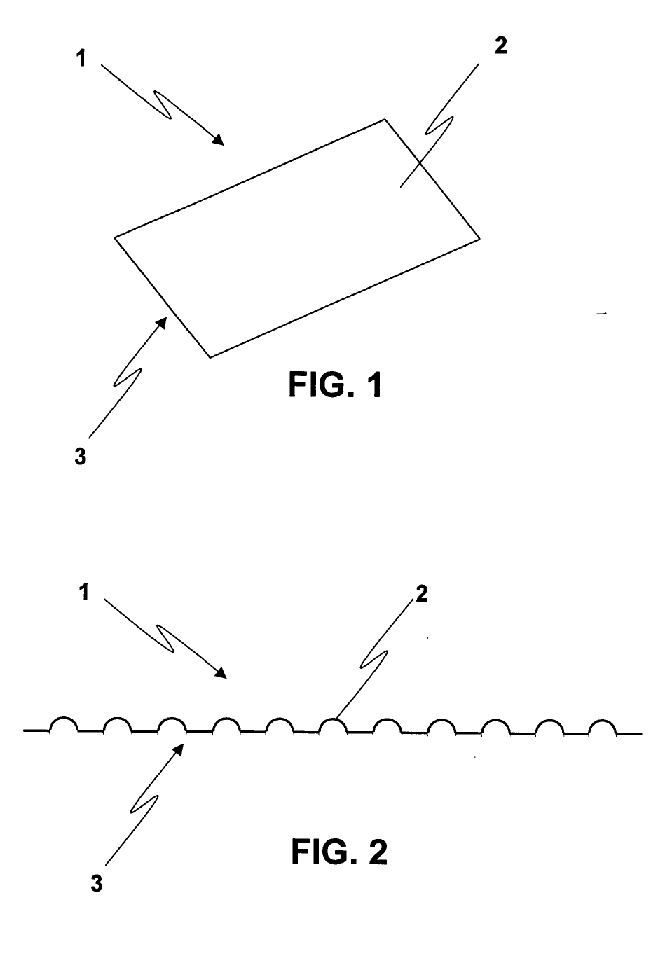

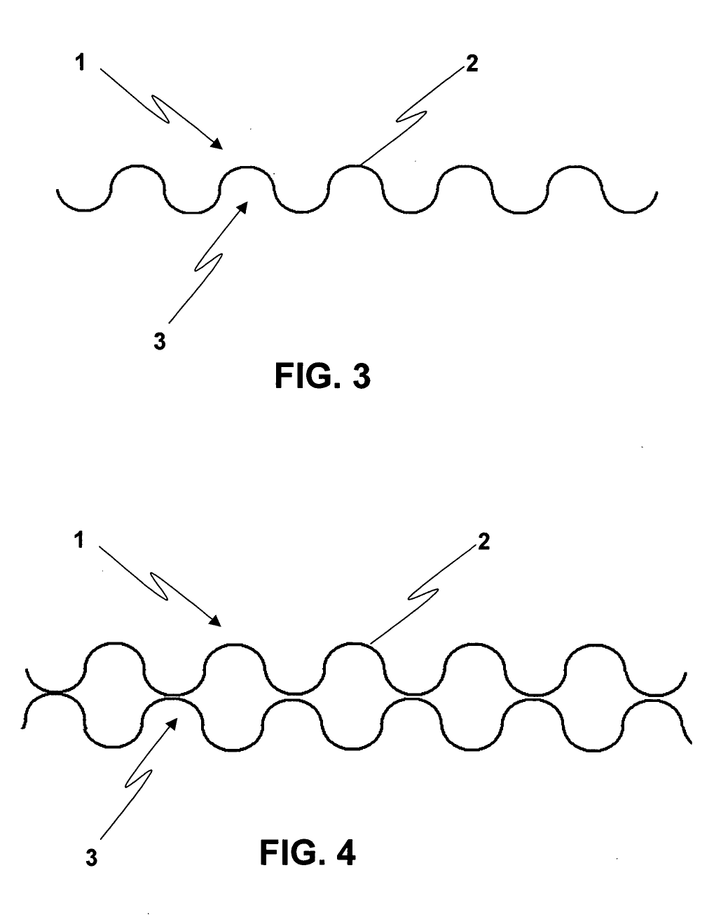

As is shown in FIGS. 2, 3 and 4, the type of embossed paper can have different structures, which can use one or more sheets to improve the absorption capacity of the disposable place mat.

The sheet of embossed paper is preferably manufactured using virgin mechanical pulp that can vary between 40 g/m² and 100 g/m² with an embossed texture, in a natural beige-cream color, with no tinting or coloring. This sheet can be printed in up to six colors, depending on the requirements of each user.

1. A disposable place mat comprising embossed paper and printed publicity on an upper face of the place mat, wherein the embossed paper is capable of cleaning a surface on which the place mat is used.

2. A disposable place mat according to claim 1, wherein the publicity is printed on the entire surface of the upper face.

3. A disposable place mat according to claim 1, wherein the publicity is printed on the upper face, leaving lateral margins.

4. A disposable place mat according to claim 1, said place mat further comprising one or more sheets to improve its absorption capacity.

5. A method of making a place mat comprising forming a place mat from embossed paper, and printing publicity on an upper face of the place mat, wherein the place mat can be used for.

6. A method according to claim 5, further comprising printing the publicity on the entire upper surface of the place mat.

7. A method according to claim 5, further comprising printing the publicity on the upper surface of the place mat, leaving lateral margins.

8. A method according to claim 5, further comprising forming, the place mat from one or more sheets to improve its absorption capacity.

9. A disposable place mat according to claim 1, wherein said place mat comprises a rectangular sheet.
